(19) United States
(12) Patent Application Publication
(10) Pub. No.: US 2010/0066025 A1
(43) Pub. Date: Mar. 18, 2010

(54) Vehicle Seal With Sensor Feedback

(76) Inventor: Craig J. Kreil, Mishawaka, IN (US)

Correspondence Address: QUARLES & BRADY LLP, 411 E. WISCONSIN AVENUE, SUITE 2040, MILWAUKEE, WI, 53202-4497, US

(21) Appl. No.: 12/562,318

(22) Filed: Sep. 18, 2009

Related U.S. Application Data
(60) Provisional application No. 61/098,127, filed on Sep. 18, 2008.

(51) Int. Cl. F16J 15/48

(52) U.S. Cl. 277/315; 277/646

(57) ABSTRACT

The invention provides a seal for a slide-out room of a recreational vehicle. The slide-out room is movable in a range of positions including a retracted position and an extended position. The seal is compressible between the slide-out room and a side wall of the vehicle and includes at least one sensor capable of detecting a force or a lack thereof on the seal, to indicate if adequate compression of the seal has been achieved in a stop position of the room or if there is an obstruction in between the stop positions.

### CROSS-REFERENCE TO RELATED APPLICATION

This claims the benefit of U.S. Provisional Patent Application No. 61/098,127 filed Sep. 18, 2008, which is hereby incorporated by reference for all purposes.

### STATEMENT REGARDING FEDERALLY SPONSORED RESEARCH OR DEVELOPMENT

Not applicable.

### FIELD OF THE INVENTION

The invention relates to a seal on a slide-out room of a recreational vehicle.

### BACKGROUND OF THE INVENTION

Recreational vehicles such as travel trailers and motor homes may include a slide-out room to increase the size of the living quarters of the vehicle while also permitting an appropriate size for highway travel. The slide-out room is typically moved by a number of actuators, such as hydraulic cylinders, electric drive screws or electric gear drives located on the recreational vehicle. Slide-out rooms include mechanical or programmable stops to define the retracted and extended positions of the slide-out room. Additionally, slide-out rooms typically include seals at the inside and outside interface with the stationary wall of the vehicle to prevent drafts, moisture and insect intrusion into the living quarters of the recreational vehicle.

The effectiveness of the seals on slide-out rooms can be compromised, however. For example, the seals are not effective if the slide-out room does not stop at a position that is not fully extended or fully retracted. In addition, the seals may assume a ‘set’ position over a number of cycles of extending and retracting the slide-out room. This prevents the seal from adequately compressing against an adjacent surface. Due to the above reasons, a need exists for an improved seal on a slide-out room of a recreational vehicle.

### SUMMARY OF THE INVENTION

The invention provides a seal for a slide-out room of a recreational vehicle. The slide-out room is movable between a retracted position and an extended position. The seal is compressible between the slide-out room and a side wall of the vehicle and includes at least one sensor capable of indicating if adequate compression of the seal has been achieved. In one aspect of the invention, the sensor may be a plurality of membrane switches. The plurality of membrane switches may be capable of indicating if adequate compression has been achieved at multiple areas of the seal. In another aspect of the invention, the seal may be inflatable. In this case, the sensor may be an air pressure sensor.

The sensor may also include the capability of sending a signal to indicate contact with an obstruction. Motion of the slide-out room is preferably stopped in the presence of an obstruction.

The foregoing and other objects and advantages of the invention will appear in the detailed description that follows. In the description, reference is made to the accompanying drawings that illustrate a preferred embodiment of the invention.

### BRIEF DESCRIPTION OF THE DRAWINGS

FIG. 1 is a perspective view of a recreational vehicle with a slide-out room;

FIG. 2 is a perspective view of the recreational vehicle of FIG. 1 showing room slides on the bottom of the vehicle;

FIG. 3 is a sectioned view of the recreational vehicle and the slide-out room from the plane of the line 3-3 of FIG. 1; and

FIG. 4 is a front view of the slide-out room of FIG. 1;

### DETAILED DESCRIPTION OF THE PREFERRED EMBODIMENT

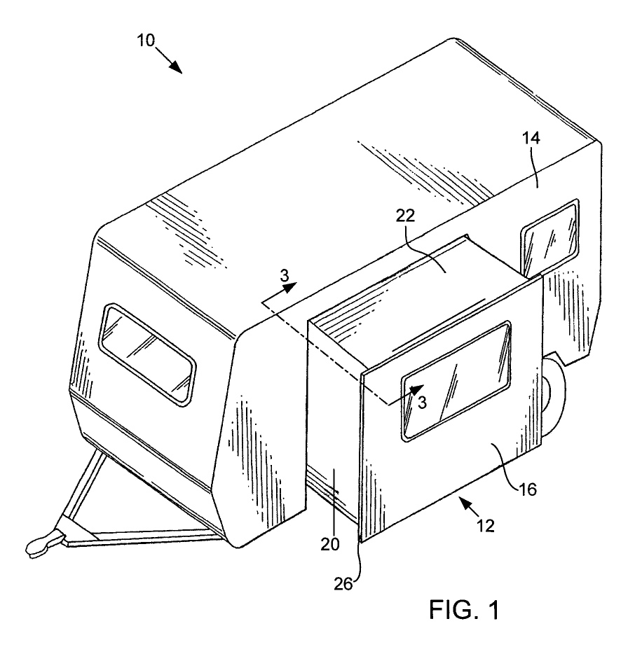

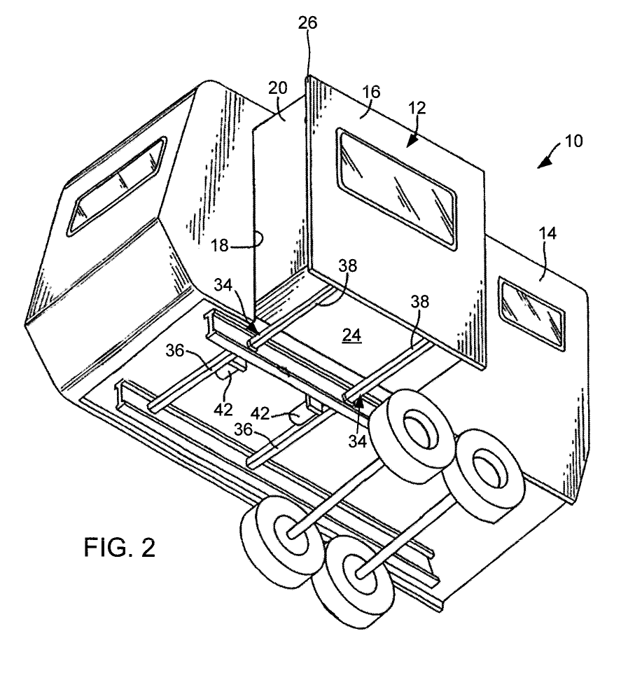

Referring to FIGS. 1 and 2, a recreational vehicle 10 includes a slide-out room 12 located in an opening 18 on a side wall 14. The slide-out room 12 includes a leading wall 16, side walls 20, a ceiling 22, and a floor 24. The leading wall 16 includes a fascia 26. The plane of the fascia 26 is parallel to the respective planes of the opening 18 and the side wall 14. The slide-out room 12 is movable between extended and retracted positions and may include a locking mechanism that prevents the slide-out room 12 from moving unintentionally. The slide out room 12 is stopped by mechanical or programmable stops in the retracted and extended positions. Programmable stops may be positions stored by a controller (not shown) that define the retracted and extended positions of the slide-out room 12.

One or more of room slide mechanisms 34 are included above or below the floor of the recreational vehicle 10. The room slides 34 extend and retract the slide-out room 12. The number of room slides 34 is typically between one and four depending on the size of the recreational vehicle 10, the size of the slide-out room 12, and the power output of each room slide 34. Two slides 34 are illustrated for the room 12 in FIG. 2. Each room slide mechanism 34 includes a slide body 36, an extending section 38, mounting supports (not shown), and a drive unit 42. A free end of the extending section 38 attaches to the fascia 26 of the slide-out room 12. The mounting supports attach the slide body 36 to the bottom of the recreational vehicle 10. Both the extending section 38 and the mounting supports can be connected to their respective section by welding or standard fasteners, such as bolts, screws, and the like. Several types of room slides are known in the art and may be used. For example, the room slides may be electric power screws, hydraulic cylinders, electric rack and pinion, cable or chain drive assemblies. If the drive units 42 are electric they may include dynamic brakes to automatically stop the room slides 34 if power is interrupted. The drive unit 42 of each room slide 34 may be operably connected to the controller that ensures synchronized motion of the room slides 34, or synchronization may be provided mechanically.

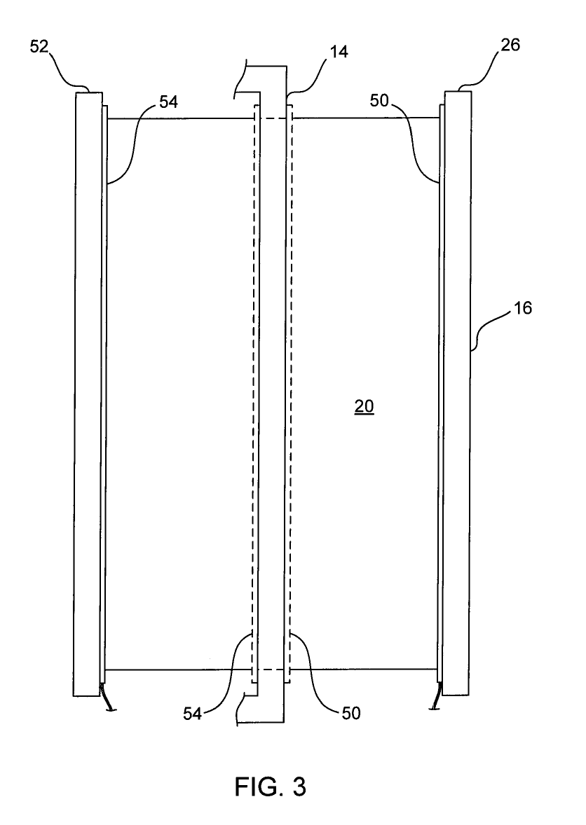

Referring to FIG. 3, the surface of the fascia 26 facing the side wall 14 includes a seal 50. The seal is compressed between the fascia 26 and the side wall 14 when the slide-out room 12 is retracted. This seal prevents leaks between the cabin of the recreational vehicle 10 and its environment when the slide-out room 12 is retracted. The side walls 20 of the slide-out room 12 also include a flange section 52 located inside the vehicle 10. The surface of the flange section 52 facing the side wall 14 includes a seal 54. The seal prevents leaks between the cabin of the recreational vehicle 10 and its environment when the slide-out room 12 is extended. Alternatively, the seals 50 and 54 may be positioned on the outer and inner surfaces of the side wall 14, respectively. The seals 50 and 54 can include sensors that are operably connected to the controller of the vehicle. This aspect will be discussed in further detail below.

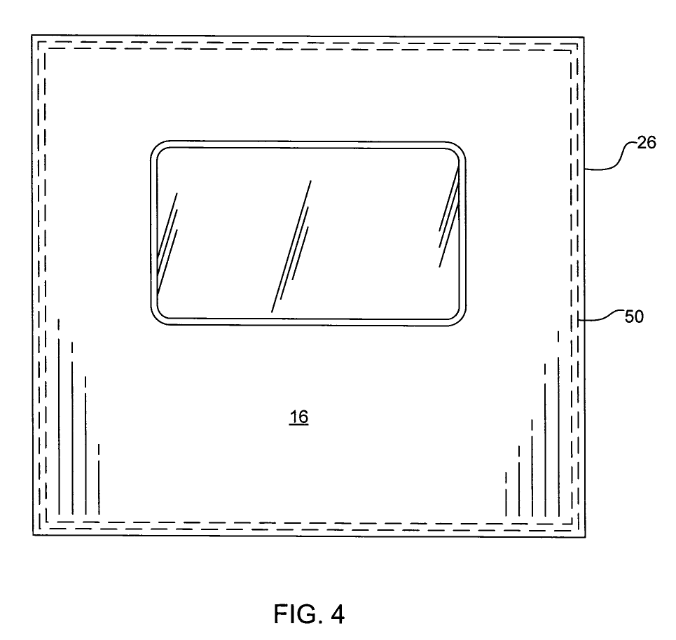

Referring to FIG. 4, the seal 50 extends around the perimeter of the fascia 26 outside of the side walls 20, the ceiling 22, and the floor 24 of the slide-out room 12. The seal 54 also extends around the perimeter of the flange section 52 in a similar manner.

The seals 50 and 54 may be inflatable. The seals 50 and 54 may each include a single inflatable compartment or multiple inflatable compartments. The seals 50 and 54 are preferably deflated or partially deflated when the slide out room 12 moves between the retracted and extended positions. In addition, there is preferably enough space for the seal 50 or 54 to further inflate and provide adequate compression with the side wall 14 when the room is positioned at the retracted or the extended position, respectively.

The seals 50 and 54 include sensors capable of providing signals to the controller. These signals permit the controller to determine if adequate seal compression has been established between either seal 50 or 54 and the side wall 14, or the fascia 26 or 52. The sensors may be, for example, membrane switches or other switches that are actuated by the contact force with the side wall 14. Membrane switches may be used with inflatable or non-inflatable seals 50 and 54. If membrane switches are used, they are preferably used in a manner that permits the controller to determine if adequate seal compression has been achieved at multiple areas on the seal, and to identify which area is experiencing inadequate seal compression, or seal compression when no seal compression is expected, for example seal compression at an intermediate position indicating an obstruction has been encountered. Alternatively, an air pressure sensor (not shown) may be used if the seals 50 and 54 are inflatable. A single air pressure sensor may be provided for each seal 50 and 54 if each seal 50 and 54 includes a single compartment. An air pressure sensor may be provided for each compartment if the seals 50 and 54 have multiple compartments. In either case, the air pressure sensors would permit the controller to monitor the air pressure in the seals 50 and 54, and if there are separate compartments in each seal, to monitor the pressure of each compartment and to identify which compartment has an air pressure that is outside of prescribed limits, either too low if in a stop position, indicating inadequate seal compression, or too high if in and intermediate position, indicating an obstruction. If adequate seal compression has not been achieved, the controller may power one or more of the room slides 34 to further compress the seal 50 or 54 against the side wall 14 of the vehicle 10. If an obstruction is sensed, movement of the room would be stopped by the controller until the problem is corrected or a manual reset or override switch is activated.

As mentioned above, the sensors on the seals 50 and 54 are preferably also capable of providing signals to the controller to permit the controller to detect if an obstruction has been caught between the fascia 26 or 52 of the slide-out room 12 and the side wall 14 during respective retraction or extension. If membrane switches are used, for example, the controller will stop motion of the slide-out room 12 if a membrane switch is actuated by the contact force of an obstruction. If air pressure sensors are used for inflatable seals 50 and 54, the controller would stop motion of the slide-out room 12 if the air pressure increases suddenly at an intermediate position (short of one of the stop positions).

Alternatively, the sensors may be limited to certain parts of the seals 50 and 54. For example, it may be sufficient to include membrane switches only on the parts of the seals 50 and 54 that extend up the side walls 20 of the slide-out room 12. Similarly, it may not be necessary to provide membrane switches along the entire length up the side walls 20 of the slide-out room 12. As another example, it may be sufficient to provide sensors only at the four corners of the seal 50 shown in FIG. 4. Other sensor arrangements are possible and will be apparent to those skilled in the art.

A controller capable of determining if adequate seal compression has been achieved and detecting obstructions would also require the capability of distinguishing seal compression from obstruction contact. Using programmable stops may be advantageous in this situation. If the slide-out room 12 is near either the retracted or the extended position, the controller could switch to an operating mode in which it is only capable of determining if adequate seal compression has been achieved. Conversely, if the slide-out room 12 is not near either the retracted or the extended position, the controller could switch to an operating mode in which it is only capable of detecting obstructions between the fascia 26 of the slide-out room 12 and the side wall 14.

The present invention should not be limited to the embodiments and illustrations contained herein, but should include modified forms of those embodiments including portions of the embodiments and combinations of elements of different embodiments as come within the scope of the following claims.

1. A seal for a slide-out room of a recreational vehicle, the slide-out room being movable between a retracted position and an extended position, comprising:
a seal that is compressible between the slide-out room and a side wall of the vehicle; and
at least one sensor capable of indicating compression of at least part of the seal.

2. The seal of claim 1, wherein the sensor includes a plurality of membrane switches.

3. The seal of claim 1, wherein the sensor includes an air pressure sensor.

4. The seal of claim 1, wherein the seal is located on at least one of a fascia of the slide-out room and a side wall of the recreational vehicle, and the seal is compressed between the fascia and the side wall when the slide-out room is in a retracted position.

5. The seal of claim 1, wherein the seal is located on at least one of a flange of the slide-out room and a side wall of the recreational vehicle, and the seal is compressed between the flange and the side wall when the slide-out room is in an extended position.

6. The seal of claim 1, wherein the seal is inflatable.

7. The seal of claim 6, wherein the seal is at least partially deflated when the slide-out room moves.

8. A system for moving a slide-out room of a vehicle, the slide-out room being movable between a retracted position and an extended position, the system comprising:
at least one actuator capable of exerting a force on the slide-out room to move the slide-out room relative to the vehicle;
a controller operably connected to the at least one actuator to control the at least one actuator;
at least one seal that is compressible against a side wall of the vehicle;
at least one sensor capable of sending a signal to the controller to indicate a force on the seal.

9. The system of claim 8, wherein the system includes multiple seals, at least one said seal being compressible against the side wall of the vehicle when the slide-out room is extended, and another of said seals being compressible against the side wall of the vehicle when the slide-out room is retracted.

10. The system of claim 8, wherein the sensor is capable of sending a signal to the controller to indicate contact with an obstruction.

11. The system of claim 9, wherein the sensor includes at least one of a membrane switch or a pressure operated switch.

12. The system of claim 8, wherein the sensor includes a plurality of membrane switches positioned at different positions around the seal.

13. The system of claim 12, wherein the plurality of membrane switches is capable of sending signals to the controller to indicate a force or lack thereof on the seal at the position of each of the membrane switches and the controller can identify the position of the force or lack thereof and with that information control the actuator accordingly.

14. The system of claim 8, wherein the seal is inflatable and the sensor includes an air pressure sensor.

15. A method for moving a slide-out room of a vehicle, the slide-out room being movable between a retracted position and an extended position and having a seal between the slideout room and a stationary wall of the vehicle, comprising the steps of:
exerting a force on the slide-out room to move the slide-out room relative to the vehicle;
sending a signal to a controller to indicate a force or lack thereof on the seal; and
exerting an additional force on the slide-out room to alleviate inadequate compression of the seal in response to a signal indicating a lack of force on the seal.

16. The method of claim 15, further including the step of detecting obstructions between the slide-out room and a side wall of the vehicle by the sensor detecting a force on the seal.

17. The method of claim 16, further including the step of stopping motion of the slide-out room in the presence of a detected obstruction between the slide-out room and the side wall of the vehicle.

18. The method of claim 16, further including the step of switching between determining compression adequacy of the seal and detecting obstructions.
